(19) United States
(12) Patent Application Publication
(10) Pub. No.: US 2020/0058049 A1
(43) Pub. Date: Feb. 20, 2020

(54) A SYSTEM AND METHOD FOR PROVIDING DATA

(71) Applicant: EUREKA MOBILE ADVERTISING LIMITED, Greater London (GB)

(72) Inventor: Rahul JAYAWANT, Greater London (GB)

(21) Appl. No.: 16/487,526

(22) PCT Filed: Feb. 19, 2018
(86) PCT No.: PCT/GB2018/050431

§ 371 Date: Aug. 21, 2019

(30) Foreign Application Priority Data
Feb. 21, 2017 (IN) 201711006057

(51) Int. Cl. G06Q 30/02; H04L 29/08

(52) U.S. Cl. CPC G06Q 30/0251; G06Q 30/0277; G06Q 30/0242; H04L 67/322; H04L 67/306

(57) ABSTRACT

A system for delivering information to a handheld device, the system comprising: an information inventory containing information to be delivered, an information serving engine, a targeting engine, a subscriber database and a subscriber-information matching arrangement, wherein: the subscriber database contains information about subscribers to which information is to be provided, and the targeting engine is configured to determine which information is to be provided to which subscribers and at what time and/or date, based on information regarding the subscribers stored in the subscriber database; the subscriber-information matching arrangement takes the information to be delivered during a predetermined period and the selected subscribers and matches them together; and the information to be delivered during the predetermined period is delivered to the selected subscribers by transmitting the information to the handheld device at a time of low network usage, and the information includes display schedule data, instructing that the information is displayed to the subscriber on the handheld device at the set times and/or dates, to be viewed by the subscriber, and the information to be delivered takes the form of a combination of initial information and second information, and first time data representing a first length of time associated with the initial information, where the second information is related to the initial information, and the initial and second information are stored as separate data files, wherein: the initial information is displayed to user for a first length of time; the first information is replaced by the second information after a first length of time without any action being required on the user's part.

### DESCRIPTION OF INVENTION

The present invention relates to a system and method for the provision of data, and more specifically, a system and method for the efficient provision of data in a mobile or cellular environment.

Particularly, it is desirable to be able to provide targeted data messages to mobile or cellular subscribers. It is also desirable to tailor the content of the messages in dependence upon pre-set conditions, such that relevant information is made available to a subscriber.

Additionally, it is desirable to be able to provide targeted information notices to mobile subscribers, based on real-time events. Particularly, it is desirable to provide information which has direct relevance to the daily activity or activities of a mobile subscriber.

### BACKGROUND OF INVENTION

WO2015/059434 discloses a system in which messages (which may be technical announcements or commercial messages) are transmitted to a user's device at times of low network usage, and displayed to the user immediately after the user's device is unlocked. While systems of this kind have been successful, there is a need in the technical field to provide an improved method of transmitting and displaying messages, which is more convenient and engaging for users.

The present invention seeks to provide a system and method to allow targeted data to be transmitted to subscribers in a mobile or cellular environment.

One aspect of the invention provides a system for delivering information to a handheld device, the system comprising: an information inventory containing information to be delivered, an information serving engine, a targeting engine, a subscriber database and a subscriber-information matching arrangement, wherein: the subscriber database contains information about subscribers to which information is to be provided, and the targeting engine is configured to determine which information is to be provided to which subscribers and at what time and/or date, based on information regarding the subscribers stored in the subscriber database; the subscriber-information matching arrangement takes the information to be delivered during a predetermined period and the selected subscribers and matches them together; and the information to be delivered during the predetermined period is delivered to the selected subscribers by transmitting the information to the handheld device at a time of low network usage, and the information includes display schedule data, instructing that the information is displayed to the subscriber on the handheld device at the set times and/or dates, to be viewed by the subscriber, and the information to be delivered takes the form of a combination of initial information and second information, and first time data representing a first length of time associated with the initial information, where the second information is related to the initial information, and the initial and second information are stored as separate data files, wherein: the initial information is displayed to user for a first length of time; the first information is replaced by the second information after a first length of time without any action being required on the user's part.

Advantageously, the initial information and second information are stored in different file formats.

Preferably, the initial information is stored as one of: a still image file, a video file, and a web page file.

Conveniently, the second information is stored as one of: a still image file, a video file, and a web page file, and is not stored as the same one of these as which the initial information is stored.

Advantageously, the first length of time is fixed in length.

Preferably, the first length of time has at least an element of randomisation.

Conveniently, the first length of time is randomised between lower and upper limits which are defined as part of the first time data.

Advantageously, the first length of time is not connected with any loading time for the second information.

Preferably, the information to be delivered further comprises second time data, wherein the second information is displayed for a second length of time which is dictated by the second time data.

Conveniently, following the second length of time, the handheld device is returned to normal operation.

Advantageously, during the display of either the initial information or the second information on the handheld device, the user may dismiss the initial or second information and return to the normal operation of the handheld device.

Preferably, during the display of the initial information and/or the second information, the user may interact with the initial and/or second information to establish a connection over the internet with a third party.

Conveniently, if the user interacts with the initial and/or second information to establish a connection over the internet with a third party, information is transmitted from the handheld device to the third party.

Advantageously, if the user interacts with the initial and/or second information to establish a connection over the internet with a third party, further information is downloaded to the handheld device from the third party for display or presentation on the device.

Preferably, the initial and second information and the first time data are transmitted to the handheld device together as a package of data.

Conveniently, the handheld device is a cellular telephone or a tablet.

Advantageously, a subscriber may opt in to information delivery system.

Preferably, the information regarding the subscribers includes demographic information.

Conveniently, the information to be delivered is provided by an external party.

Advantageously, the set time is not the same as the predetermined delivery period.

Preferably, the information further includes a data flag which causes the information to be displayed when the handheld device is unlocked, altering the normal user navigation of the handheld device.

Conveniently, the data flag causes the information to be displayed on the screen of the handheld device immediately after the lock screen is dismissed, altering the normal user navigation of the handheld device.

Advantageously, the data flag is set such that the subscriber must indicate that they have read the information prior to the information being removed from the screen of the handheld device.

Preferably, the information further includes a data flag which causes the information to be displayed when a call is dismissed on the handheld device.

Conveniently, the initial information to be delivered includes a network service message, and the second information preferably allows the user to acknowledge that the network service message has been read.

Advantageously, the initial information to be delivered includes a software update alert, and the second information preferably allows the user to acknowledge that the software update alert has been read.

Preferably, the initial information comprises first information about a product or service, and the second information comprises further information about the same product or service, and the initial information and/or the second information allows the user to establish a connection with a provider of the product or service over the internet.

Conveniently, the initial information to be delivered includes a traffic or news alert.

Advantageously, the initial information to be delivered includes an advertisement, and the second information preferably comprises a voucher or coupon which can be selected or activated by the user.

Preferably, the initial information to be delivered includes display of marketing communications and/or marketing information, and the second information preferably comprises a voucher or coupon which can be selected or activated by the user.

Conveniently, the second information is replaced by third information after the second length of time, without any action being required on the user's part, wherein the third information is related to the second information.

Preferably, the system further comprises an action log, wherein when the information is viewed by the subscriber, a read acknowledgement is sent to the action log.

Another aspect of the invention provides a combination of the system as defined above and a handheld device, wherein the handheld device includes an application configured to receive and display the information delivered by the system, and wherein the application is configured to display the information according to the display schedule data.

Preferably, the application determines when the information is to be displayed on the device.

Conveniently, the application is configured to display the information on a post-lock screen.

Advantageously, the post-lock screen is an idle screen on the handheld device.

A further aspect of the invention provides a method for delivering information, the method comprising: providing information to be delivered, stored in an information inventory, to be delivered by an information serving engine; analysing information stored in a subscriber database about subscribers to which information is to be provided; determining which information is to be provided to which subscribers and at what time and/or date by way of a targeting engine, the determination based on information regarding the subscribers stored in the subscriber database and the information stored in the information inventory; providing a subscriber-information matching arrangement which determines which information is to be delivered during a predetermined period; taking the information to be delivered during the predetermined period and the selected subscribers and matching them together; determining when network usage is low; delivering the information to be displayed during the predetermined period to the selected subscribers by transmitting the information to a handheld device at the determined time of low network usage; including, in the information, display schedule data which instructs a handheld device to display the information and displaying the information to a subscriber on a handheld device at the set times and/or dates, to be viewed by the subscriber, wherein the information to be delivered takes the form of a combination of initial information and second information, and first time data representing a first length of time associated with the initial information, where the second information is related to the initial information, and the initial and second information are stored as separate data files, wherein: the initial information is displayed to the user for a first length of time; the first information is replaced by the second information after a first length of time without any action being required on the user's part.

The present invention will now be described with reference to the accompanying figures, in which:

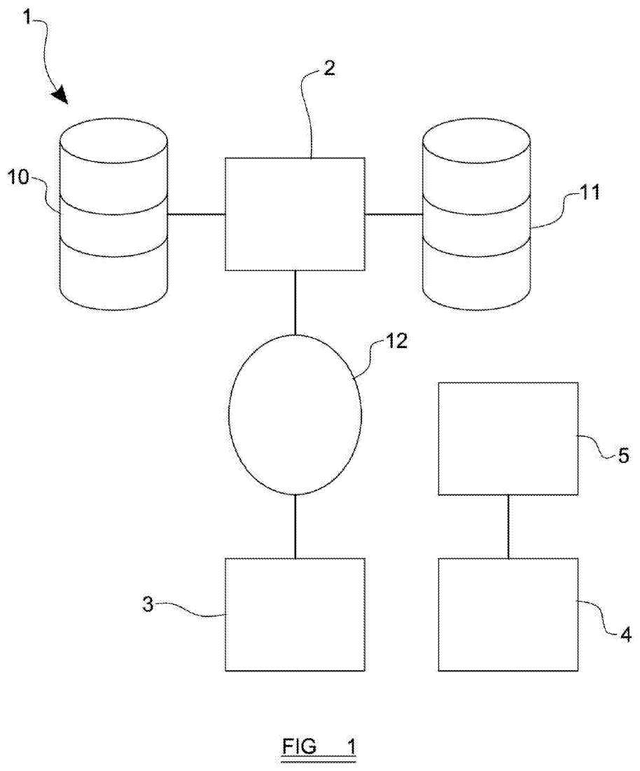

FIG. 1 shows a schematic representation of a data providing system; and

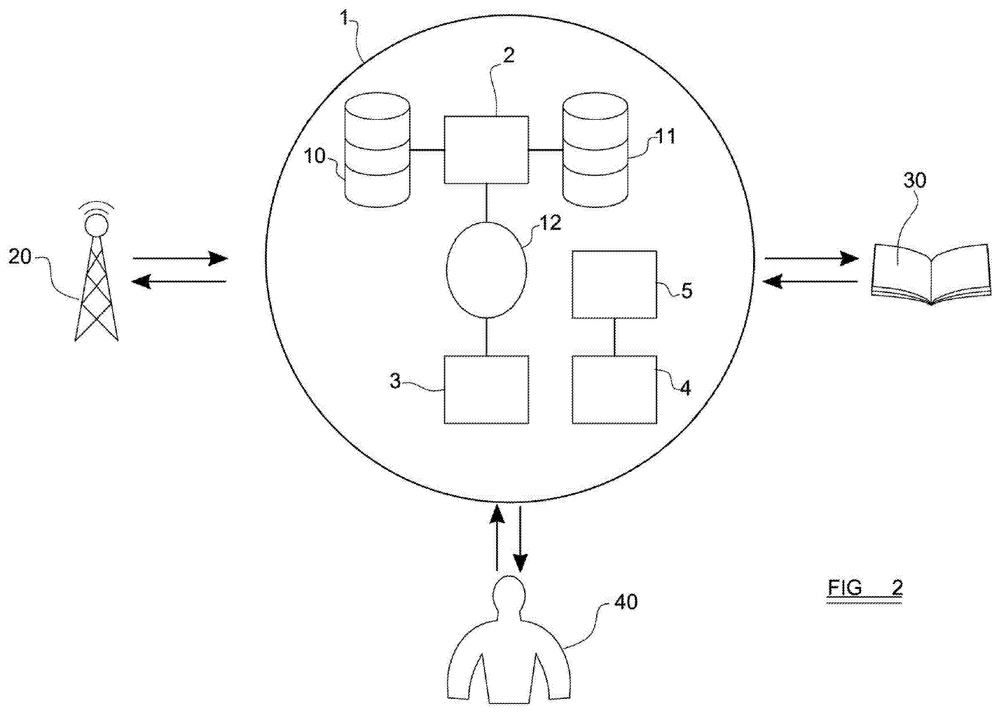

FIG. 2 shows a schematic representation of a data providing system with further infrastructure attached.

Turning firstly to FIG. 1, a schematic representation of the system 1 which embodies the present invention is shown. The system 1 may include a targeting engine 2, an information serving engine 3, an action log 4, an analytics engine 5, a subscriber database 10, an information inventory 11 and a subscriber-information matching arrangement 12. The subscriber-information matching arrangement 12 may include a result set which has been created by the targeting engine 2, which may match information from the information inventory 11 with subscriber demographic data (discussed later) from the subscriber database 10.

FIG. 2 shows the system 1 of FIG. 1 connected to a telecoms operator 20, an information provider 30 and a subscriber 40. The system 1 may be connected to each of these 20, 30, 40 by one- or two-way communication, and the telecoms operator 20 and subscriber 40 may also be connected outside of the system 1. In normal operating circumstances, the information provider 30 may not be connected directly to the operator 20 or subscriber 40 outside of the system 1.

Returning to a discussion of the system 1 shown in FIG. 1, the system 1 may be operable to transmit an information message 41 to the telecoms subscriber 40 (not shown). The information message 41 may include any type of data, and may include alerts or general information. The form and content of the information message 41 will be discussed in more detail later.

The system 1 may also be operable to direct particular information messages 41 to particular subscribers 40, dependent upon pre-set conditions. The way in which this message direction operates will be discussed briefly here, and in more detail below.

The information inventory 11 may be pre-loaded with information 41 to be provided to subscribers 40, or may be loaded with information on an ad-hoc basis. The information 41 may be provided by an information provider 30, and may also comprise a multitude of individual information items 42. The information provider 30 may load the information inventory 11 using an information loading system, which may take the form of a web portal or similar. The information provider 30 may identify details of the information 41, details of actions to be taken when a subscriber 40 interacts with the information 41 as well as provide scheduling data which may specify when that particular information 41 should be shown to a subscriber 40.

The information items 42 may be catalogued for ease of reference and location. The subscriber database 10 may include details of each subscriber on a cellular or mobile network, or only the details of subscribers who subscribe to the information provision system 1. The information provision service 1, by way of the information serving engine 3, action log 4, an analytics engine 5, and subscriber-information matching engine 12 is operable to provide the targeted information messages 41.

The information serving engine 3 may take information 42 from the information inventory 11, passed via the subscriber-information matching engine 12. The matching engine 12 may also take data from the subscriber database 10.

The information 42 may then be matched to a subscriber or subscribers 40, and readied for transmission from the system 1 to the subscriber or subscribers 40. The way in which the information 41 is transmitted to the subscriber or subscribers 40 will be discussed in more detail later.

Once the information 41 has been transmitted to a subscriber's handset or device, the information 41 may be presented to the subscriber 40. The information 41 that is transmitted may include multiple messages or items of data 42, and may be displayed at particular times or on particular dates. If this is the case, the time and/or date of display of the data may be set by the targeting engine 2. Alternatively, the system 1 may further include a scheduling engine 50, which may determine which information 41, 42 is shown at what time and/or in what sequence to the subscriber 40.

In some embodiments of the invention, the information 41, 42 may be displayed on the screen of a subscriber's handset or device at a pre-set time, regardless of the current state of operation of the subscriber's device. This may cause the information 41, 42 to be displayed in place of the current screen contents, and the device may not be returned to normal operation until the subscriber 40 has viewed the information 41, 42 as detailed below. In other embodiments of the invention, the information 41, 42 may be displayed on a ‘post-lock’ screen.

The ‘post-lock’ screen may be a device ‘idle screen’. The device may be maintained in an idle state whilst the post-lock screen is displayed.

If the information 41, 42 is displayed on such a post-lock screen, the information 41, 42 may be presented to a subscriber on the screen of their handset or device when the device is powered up, immediately after the handset is ‘unlocked’ or brought out of standby. Many popular handsets presently employ a ‘swipe to unlock’ feature, or may require a PIN or alphanumeric code, or another identifier such as the user's fingerprint, or iris identifier to be entered to unlock the handset. In the case of Android® handsets, the user may be required to swipe their finger in a particular pattern upon the screen to unlock the device.

After the handset or device is unlocked, the information 41, 42 may then immediately be displayed on the screen of the handset or device, such that a subscriber must view the information 41, 42 before being able to access the unlocked device to continue normal operation. Such a method of information 41, 42 display alters the user navigation of a handset or device, preventing normal operation of the device from occurring until the subscriber 40 has viewed the information 41, 42, discussed in more detail below. Such alteration of the user navigation of a device may also ensure that a subscriber 40 sees the information 41, 42. Further, an alert may be displayed on the lock screen of the handset or device, to alert the subscriber that there is information 41, 42 to be viewed on unlocking the handset or device.

The information 41, 42 may include a selection of options that a subscriber 40 may be presented with. These options may include (but are not limited to) touching the screen when the information is shown, which may in turn launch a browser window to route the subscriber 40 to a pre-determined link that was specified as part of the information 41, 42.

Further, the subscriber 40 can dismiss the information 41, 42 by swiping the screen, or, alternatively, by selecting a dismiss option which may be presented. This may then allow the subscriber 40 to continue normal operation of the device and may return the user navigation of the device to a normal state. A contextual menu may be launched by clicking on the Menu button of the device. ‘Show me later’, ‘save’, ‘like’ and ‘share’ functions may also be provided. ‘Show me later’ may queue the information 41, 42 behind the next piece of information 41, 42 scheduled to be shown to the subscriber at that point in time, or may be configured such that the information is shown again after unlocking the device, after a pre-determined period. If a subscriber 40 indicates that they would like to save the information to view later, the information may be saved in the application for off-line or later viewing. The ‘like’ and ‘share’ option may be used to allow a subscriber 40 respectively to indicate that they like the content of the information 41, 42, or may forward the information 41, 42 to another subscriber 40.

In preferred embodiments of the invention, at least some of the information 41, 42 takes the following form. Initial and second information are transmitted to the handheld device (preferably together as a “package”), along with first time data specifying a first length of time, as will be discussed below. The initial and second information are related to each other. Firstly, the initial information is presented on the screen. If the user takes no action then the initial information will be maintained on the screen for the first length of time.

During this first length of time, the user may wait and take no action, and allow the first length of time to come to an end. After the first length of time, without any further action or prompting from the user, the initial information disappears (entirely or partially) from the screen, and is replaced (again, entirely or partially) by the second information.

The user may preferably (although not in all cases) interact with the second information, as discussed in more detail below.

The initial and second information generally comprise information that may be viewed by a user, or otherwise presented to a user, and may for instance comprise:
A still image encoded in any suitable kind of image file, such as a JPEG, TIFF, GIF, BMP or PNG file format.
A video sequence, encoded in any suitable file format, such as MPG, GIF or AVI format.
A web page or similar, encoded in HTML or any other suitable format.
A document of any kind, comprising a file in MS Word format, Adobe pdf format, or any other suitable format.
A sound file, encoded in (for example) MIDI or WAV file format.

Examples of related initial and second information include the following:
The initial information comprises a technical message to the user of the handset, for example telling him/her about a software update, scheduled service outage, or security alert. The second information comprises a button which the user can select (or other method for the user to give feedback) confirming that the user has read and understood the technical message. The first length of time may be set at a reasonable length of time for the user to read and absorb the technical message given in the initial information, and may therefore be dependent upon the length and/or complexity of the technical message. In this example the initial information may comprise a still image, provided in a suitable image file format, and the second information may be provided in the form of a web page format.
The initial information comprises a quiz question, and the second information comprises either a set of answers (one of which is correct), and allows the user to select one of the set of answers, or displays the correct answer and allows the user to indicate whether or not the user had worked out the correct answer. In this case the first length of time may be set at a reasonable length for the user to read and understand the question, and may also allow some time for the user to try and work out the answer. In this example, the initial information may comprise a still image or video sequence, provided in a suitable file format, and the second information may be provided in the form of a web page format.
The initial information comprises an advertising message relating to one or more particular products or services. The second information comprises a voucher, coupon or reward of another kind which relates to the one or more products or services, and allows the user to select or activate the voucher etc. For example, the initial information may comprise information about a local clothing store, and the second information may comprise a voucher allowing the user a discount on certain items that are available in the store. Again, the initial information may comprise a still image or video sequence, provided in a suitable file format, and the second information may be provided in the form of a web page format. Promotion of Movies, TV Soaps or advertising TVCs (television commercials) can be launched with the initial information being a poster which dissolves in a finite time for the next information that invites the subscriber to double tap the screen to view a video, which may for instance be a trailer.
Sporting highlights can be transmitted at a specific time. In these embodiments, the initial information may be an extract (such as a goal or other highlight) from a sporting event. This dissolves after a finite time, revealing the second information that shows the latest score from, or breaking news about, the sporting event or participants of the sporting event, or be the ‘video highlight(s) of the day’ relating to that particular sport.
Enterprise broadcast, compliance or safety information can similarly be provided. The initial information on the screen could comprise first subject matter introducing and/or briefly introducing a topic (such as safety when working with particular tools), and this initial information dissolves in a finite time to be replaced by second information that expands on the same topic.

The first length of time may be fixed for the particular information that is being displayed on the screen, and the examples above give some guidance on how long the first length of time may be. Therefore, each particular message, or set of linked initial and second information, may be associated with a set and fixed duration for the first length of time. The first length of time may be, for example, 1 second, 2 seconds, 5 seconds or 10 seconds, or any other suitable length depending on the nature and content of the initial and second information. The skilled reader will understand how the first length of time may be selected for any particular example. In preferred embodiments, the first length of time is between 1 second and 30 seconds, with times at the shorter end of this range being suitable for simple information, that requires little or no processing on the part of the viewer (such as a logo or simple announcement) and times at the longer end of the range being for more complex information, that requires a greater degree of thought or consideration on the part of the user, for instance where new information is presented that must be absorbed fully, or where a question is presented that is likely to need some consideration for the viewer to reach an answer.

A third party who provides the initial information may set or suggest the first length of time. For instance, if the initial information relates to a software update, the third party may set or suggest a length of time which will allow a user to read and absorb the message about the software update, taking into account the complexity and amount of information to be absorbed.

Alternatively, if the third party is a provider of advertising content which comprises the initial information, the third party may stipulate a length of time, or minimum length of time, for which the initial information must be displayed to the user.

As a further possibility, the first length of time may be varied by the operator of the system 1. Again, the selected length of time may be based on the amount of content that is presented to the user in the initial information, and/or the complexity of the information.

As another possibility, the duration of the first length of time could include an element of randomness. For example, the first length of time could be set to have a minimum duration of 5 seconds, and a maximum duration of 10 seconds. Within this range, however, the duration of the first length of time may be randomised. An advantage of this is that interest and/or variation can be added to the experience of the subscriber when the initial information is presented.

In preferred embodiments, the first length of time is not related to any loading, download or preparation time for the second information. As discussed below, preferably the initial and second information will have been transmitted to the handheld device at a time of low network usage, and the second information will be ready for presentation to the user at any time, regardless of the duration of the first length of time. The first length of time is chosen, for example, to allow the user sufficient time to read, understand or otherwise absorb the initial information, or to maximise the user's interest in the initial information and/or second information.

In preferred embodiments, at any time during the first period of time, the user may choose to dismiss the initial information. The user may do this by tapping an exit button on the device or in any other way. However, if the user chooses to dismiss the initial information, then the second information will not be displayed to the user.

In the example of a software update, this may deprive the user of an opportunity to interact with the second information to confirm that the user has seen and understood the initial information regarding the software update. In this case, the same combination of initial information and second information may be presented to the user again on a subsequent occasion when the user unlocks his or her phone.

In the example of an advertisement, by dismissing the initial information, the user may lose the possibility of gaining a prize, voucher or other offer/reward which would have been presented as part of the second information. The combination of initial and second information may be re-scheduled for presentation to the user on a subsequent occasion when the user unlocks his or her phone. The combination of initial and second information may not be presented to the user for a set length of time (e.g. 24 hours) or a set number of phone unlocks (e.g. 10 phone unlocks), to allow variety in the advertisements/messages that the user sees.

Alternatively, or in addition, if the user dismisses some initial information, this information may be passed to the analytics engine 5, and taken into account when selecting further information to be presented to the user. For instance, if the user dismisses initial information relating to a particular brand or product, no more information relating to that brand or product may be shown to the user. In other examples, if a user consistently dismisses initial information relating to a particular brand, product or type of product, then this pattern of behaviour may be taken into account to reduce or eliminate the frequency with which information relating to that brand, product or type of product is presented to the user.

As discussed above, at the end of the first length of time, the initial information preferably disappears entirely or completely, without any prompting or action from the user being necessary. The initial information may “dissolve”, or disappear in any other suitable manner.

In some embodiments, the second information may be displayed until the user provides a response, or dismisses the second information. For example, if the initial information provided the user with a notification about a software update, the second information may remain on the screen of the user's device until (a) the user confirms that he/she has read and understood the notification, (b) the user indicates that he/she needs more information about the update, or (c) the user dismisses the second information. In the case of (a), the phone returns to normal operation. In the case of (b), a window may open for the user to type a message with a question, which can then be sent to the provider of the initial information, or to another suitable party. Following this, the initial and second information may be scheduled for presentation to the user again at a later time. In the case of (c), the second information disappears, but the initial and second information may be scheduled for presentation to the user again at a later time.

In the case of an advertisement, the second information may remain on the user's screen for an indefinite length of time, until either the user interacts with the second information or dismisses the second information. However, in other embodiments, at least some of the second information may be presented for only a certain second length of time before it disappears, or changes so that at least one way in which the user may interact with the second information is altered. If the second information comprises a voucher or coupon (as discussed above), then the user may be able to select or activate the voucher or coupon for the second length of time, after which the user will no longer be able to select or activate the voucher or coupon. If the user fails to select or activate the voucher or coupon during the second length of time, the second information may be replaced by further information relating to the same product(s) or service(s) as the initial and second information, but which does not allow any interaction.

It is envisaged that a combination of a first length of time which is variable or randomised, and a second length of time which is finite and relatively short, may effectively keep the interest of the user. The user must pay attention during the first length of time, as at any moment the initial information may disappear and be replaced by second information which offers a coupon which must be activated within a short space of time.

The second length of time may, in some examples, be around 2-5 seconds.

Second time data may be transmitted to the handheld device, along with the initial and second information and first time data (e.g. as part of the same “package” of data), with the second time data specifying the second length of time.

As with the first length of time, the second length of time may include at least an element of randomisation, which may help to maintain the user's interest in the information that is provided/displayed.

While the examples above focus on a combination of initial and second information, it is envisaged that third information, fourth information, and further subsequent information may also be provided as part of a combination of data used in accordance with embodiments of the invention.

In some examples, following the second length of time, the third information may be presented, and following a third length of time, the fourth information may be provided, and so on, without any action on the part of the user being needed. For instance, the initial, second and so on information may comprise successive images, video sequences and/or web pages showing related information on a particular topic, such as how to use a tool or software package, instruction on an academic subject, or information on a product or service. The user may therefore watch his/her device, and successive pieces or “layers” of information will be revealed to the user.

Each piece of information will be associated with an associated length of time, after which that information will entirely or partially disappear, to be replaced by the next piece of information. Any or all of these lengths of time may, as discussed above, be randomised, or be randomised within a lower and/or upper limit.

Some examples of particular combinations of initial and second information that are envisaged as falling within the scope of the invention are:

| Initial information | Second information |
|---|---|
| Still image | Web page |
| Still image | Video sequence |
| Video sequence | Web page |
| Document | Web page |
| Document | Still image |

The invention is, however, not limited to these combinations, and the skilled reader will appreciate that many other combinations will find utility in different circumstances.

If the information is shown on a post-lock screen, this may ensure that the information 41, 42 is delivered to and viewed by a subscriber 40, but also that the subscriber 40 is not inconvenienced by the display of the information 41, 42. Further, if the information 41, 42 is displayed immediately after the handset or device is unlocked, it may be possible to track whether a subscriber 40 has viewed the information 41, 42, and the time/date at which the information 41, 42 was viewed by the subscriber.

The information 41, 42 may also be displayed on the screen of the handset or device immediately following the ending of a call. If the information 41, 42 is displayed on the screen of the device as soon as a call is ended, the information 41, 42 may be presented to a subscriber on the screen of their handset or device when the ‘hang up’ or ‘end call’ button or option is pressed or selected.

As with the methods of display of information 41, 42 detailed above, the display of the information 41, 42 alters the user navigation of a handset or device, preventing normal operation of the device from occurring until the subscriber 40 has viewed the information 41, 42, as detailed above.

The portion of the system 1 on the handset or device may keep data which includes a track of each action that the subscriber 40 takes with respect to the information 41, 42, and may log whether the subscriber 40 has viewed, dismissed or saved the information 41, 42, or whether the subscriber 40 has selected the ‘show me later’ option. The application may then push this data to the action log 4.

The data from the action log 4 may then be processed by the analytics engine 5. The processing steps undertaken by the analytics engine may include analysis as to whether a subscriber or subscribers like a particular information message, behavioural patterns of subscribers 40 dependent upon the information 41, 42 provided thereto, and demographic information regarding the subscribers 40 based upon the information 41, 42 provided thereto. Further, analysis may be undertaken regarding which information 41, 42 is particularly relevant to a particular group or groups of subscribers 40.

The analytics engine 5 may also analyse all the actions that the subscriber 40 performs in connection with each item of information 41, 42, which may include requests to ‘show me later’, ‘share, ‘dismiss’ or ‘save’.

The information inventory 11 may, in combination with the subscriber database 10 and the analytics engine 5, store and keep updated information regarding which information 41, 42 has been provided to certain subscribers 40, a log of which subscriber or subscribers 40 has viewed a particular item of information 41, 42, an inventory of the information items 41, 42 available, and may be operable to undertake reporting on such information (and further information, if required). This reporting will be discussed in more detail later.

The system 1 may also provide an application for a mobile device or handset which, when launched by a subscriber, may display the information 41, 42 which has been delivered to the device or handset, and may also include a selection of options that a subscriber 40 may be presented with. These options may include (but are not limited to) clicking a link in the information 41, 42, which may launch a browser window to provide further information.

‘Show me later’, ‘save’, ‘like’ and ‘share’ functions may also be provided, such that a subscriber may save the information to view later (it may be configured such that the information is shown again after unlocking the device, after a pre-determined period), indicate that they like the content of the information 41, 42, or may forward the information 41, 42 to another.

For a subscriber 40 to use the service 1, the user may have to download the application to their handset or device. The subscriber may be presented with terms and conditions which may have to be accepted to commence use of the service 1. Information 41, 42 may not be provided to a subscriber 40 if they have not accepted the terms and conditions.

The application 1 may further enable a subscriber 40 to set up and/or edit details about them, which may be shared with the analytics engine 5, the subscriber-information engine 12 and any other appropriate part of the system 1. The subscriber 40 may input name, date of birth, age, email address, address, sex, contact details, interests, hobbies, and may also provide further information regarding the information 41, 42 that they may receive. The subscriber 40 may also pause the provision of information 41, 42, and/or may indicate further factors about themselves that may ensure that more important or pertinent information 41, 42 is provided to them.

The application for a handset or device may be made available online for download, and dependent upon the platform on which the application is to be provided, may take any suitable format. In the case of an Android® application, it may be delivered by way of an Android Package (or APK) file, either via the Google® Play Store® or from a download area independent of Google®.

The telecoms operator 20 or information provider 30 (or any other interested party) may undertake reporting on the system 1. The reports may include information regarding the number of information messages provided, the number of information messages viewed by a subscriber or subscribers 40, the content of the viewed information messages, the number of times that the further information link is viewed, the number of times a particular subscriber 40 has viewed a post-lock screen, the identification number or numbers of a particular subscriber 40, and whether a particular subscriber is presently accepting information 41, 42, and for how long they have been accepting information 41, 42.

Further, reports may be generated regarding particular information messages. The report may include the name of the information message, the number of times on which the message has been clicked, the number of times that the message has been liked, shared or saved for later, the identities of subscribers 40 who have viewed the message, and other relevant information.

It is to be understood that other reports may be generated which may include information available in the system 1. Reports may take any suitable format, and may be provided in any appropriate way.

Subscribers 40 may join the system 1 in a variety of ways, or may be automatically enrolled by a telecoms operator 20. A subscriber 40 may access a webpage to enroll in the service, and may be required to provide at least some of the information which is editable in the application, as discussed above. If a subscriber 40 is to be automatically enrolled in the system 1 by a telecoms operator 20, the operator 20 may provide the relevant details of the subscriber 40, which again may be at least some of the information editable in the application, discussed above.

Further, the telecom operator 20 may provide further information, which may be received by the system 1. This may be of particular relevance if the telecom operator 20 is providing the subscriber 40 information, and may include details of new subscribers, modified subscribers and deleted subscribers, and, as mentioned above, data regarding the subscribers which may include name, age, date of birth, email address, address, sex and contact details, and may also provide further information regarding the information 41, 42 that the subscriber is to receive.

The information 41, 42 is not necessarily provided to a subscriber's handset or device at the time that the information is to be shown. Instead, the information 41, 42 to be shown over a pre-set period may be aggregated, and queued for delivery to a subscriber or subscribers 40. Therefore, the information for provision on a particular day may be transmitted at times of low network usage, for instance during the early hours of the morning (for instance between the hours of 2 am and 4 am), to reduce the load on a cellular network. Such times of low network usage may ensure that the information 41, 42 is delivered quickly and without errors, and will be available for display at times when network usage may be high, for instance during peak commuter hours in the morning.

Further, if the information 41, 42 to be displayed over the course of a day is pushed to a subscriber's handset or device during times of low network usage, often at night, if the user has no cellular or data signal during the day when the information 41, 42 is to be displayed, the information 41, 42 may still be displayed to the subscriber, regardless of signal availability. This may ensure that a subscriber sees the information 41, 42 scheduled for display during the course of that day.

Also, if the information 41, 42 is pushed to a subscriber's handset or device during a time of low network usage, with the information 41, 42 subsequently presented, by way of a post-lock screen to a subscriber, the subscriber may be more likely to read and understand the content of each item of information 41, 42 if they are presented to the subscriber during the course of a day—the subscriber may be less likely to read and understand the content of the information 41, 42 if the information 41, 42 is presented to the user all at the same time.

During the daytime, and particularly during so-called ‘peak’ hours, cellular data usage is generally high, and the provision of information 41, 42 during these hours would place further load on a cellular data network, and, in some events, at times of high traffic, information 41, 42 may be delayed significantly and not provided at the appropriate time. If the information 41, 42 is provided to the device in this at times of low network usage, it may be ensured that even if a network failure occurs, the information 41, 42 is available to the subscriber.

In an effort to reduce the load on cellular networks, the system 1 of the present invention may transmit information 41, 42, as discussed above, to a subscriber's handset or device in bulk, and the information 41, 42 transmitted may be a combination of all of the information to be viewed in one particular day or pre-set time period. Of course, if further, real-time information is to be provided, further information 41, 42 may be provided to a subscriber 40 on an ad-hoc basis. Such information 41, 42 may be integrated into the display schedule as appropriate.

The system 1 may perform analysis on data transfer and bandwidth usage for a particular cellular network or telecoms operator's 20 infrastructure, and may determine the most appropriate time for transmission of information 41, 42, which may be the period at which network or cellular traffic is at its lowest.

To return to the examples given above in which initial information is presented to a user, followed by second information, it is envisaged that the initial and second information would be downloaded (as discussed above) at times of low network usage. Each combination of initial and second information is preferably associated with a “show time”, which is a time at which, or after which, the combination may be presented to a user.

If the information is to be presented on a post-lock screen, when the user unlocks his/her phone following the “show time”, the combination of initial and second information may be presented to the user (if there are one or more other combinations of first and second information which have also passed their respective “show times”, then on any one occasion when the phone is unlocked, the system will select an appropriate combination of first and second information to display to the user).

As discussed above, during either the first period of time (in which the initial information is displayed) or the second period of time (in which the second information is displayed), the user may choose to exit the information and return to the normal operation of the phone. This may be done by pressing/clicking a designated area of the screen, for instance containing an “X” symbol.

However, during either the first period of time or the second period of time, the user may also click/press on one or more other areas of the screen, to trigger the downloading and display of other content to the device. This may occur, as discussed above, through a cellular network, a Wi-Fi network, or by any other suitable means.

As an example, for a particular advertisement the initial information may comprise a still image which is displayed to the user. The still image may have been downloaded/transferred to the user's device as any suitable kind of image file, such as a JPEG, TIFF, GIF, BMP or PNG file format. The still image may comprise information about a product, or information about an offer (such as a reduced price for a product).

Following the first period of time, the initial information may disappear, to be replaced by second information giving more detailed information about the product. The second information may comprise a second still image, or alternatively may comprise a video (downloaded or transferred in any suitable file format, such as MPG, GIF or AVI format).

During either the first period of time or the second period of time, the user may press/click one or more designated areas of the screen to be connected over the internet to the provider of the product, to begin (for example) the process of placing an order for the product, and selecting parameters such as size, colour and delivery information.

In this instance, therefore, the combination of the initial information and second information would have been downloaded to the user's device at a time of low network usage, and stored on the user's device for presentation at a suitable time after the allocated “show time”. The user therefore does not need to have or make use of an internet connection in order for the initial and second information to be displayed to the user. This has the benefit that the initial and second information can be displayed swiftly and without “lag” in any circumstances. It is only when the user actively expresses interest in buying the product, by tapping/pressing the device's screen in a certain way, that the user's device is connected to the internet. This has the benefit of reducing the requirement for use of an internet connection, potentially at busy times.

As another example, a combination of initial and second information could be provided for the purposes of conducting a market survey.

In this case, the initial information may comprise a landing page, which could be a still image, showing a poster or other promotional information for a film, product or television show. After the first length of time, this initial information may disappear, and be replaced by second information, which is a page inviting the user to see a video sequence (which may be, for instance, a trailer for the film or television show, or some or all of a television commercial (TVC)), and to take part in a market survey. The second information may be provided in a web page format, for instance HTML (preferably HTML 5.0) format. The user may interact with the second information to indicate whether or not he/she wishes to view the video sequence, for instance by tapping or double-tapping the screen in a certain way when the second information is displayed.

If the user does elect to see the video sequence, the second information disappears and is replaced by the video sequence, which comprises third information, related to the second information. This third information may be transmitted to the handheld device as part of a “package” including the initial and second information, or may be downloaded/transmitted to the handheld device only when the user indicates that he/she wishes to view the video sequence.

Following the video sequence, the third information may disappear, to be replaced by a page asking one or more survey questions, and again this page may be provided in a web page format such as HTML (and preferably HTML 5.0). This page comprises fourth information, related to the initial, second and third information. Once again this fourth information may be transmitted to the handheld device as part of a package including the initial, second and third information. On completion of the survey questions(s), the user's answers to the questions can be transmitted over the internet to a third party, which may for instance be a provider of the film, product or television show. In preferred embodiments, information encoding or representing the user's answers may be the only information that is transmitted over the internet at the time when the user views and interacts with the information.

Following the video, the user is presented with third information, comprising a survey with a number of questions for the user to answer. When the user has completed the questions, the user's answers may be submitted over the internet to the provider of the service, or directly to the provider/distributor of the TVC/trailer.

In this case, again the combination of initial and second information would have been downloaded to the user's device at a time of low network usage, and stored on the user's device ready for display at the appropriate time. Particularly in the case of relatively large files such as video files (as may be used to show a TVC or film trailer), this avoids the risk of the files appearing to be slow when presented to the user, or suffering from “lag” or buffering delays. Only if the user is interested in participating in the survey is a connection to the internet required, and in this case only a relatively small amount of data would need to be transmitted over the internet connection (i.e. the user's answers to the survey questions), which will be very much smaller than the amount of data required to store the initial and second information.

The discussion above refers to initial and second information which are downloaded or transmitted (preferably as part of a single package of data) to the device at times of low network usage, and third information which can be downloaded or accessed over the internet, if desired by the user. It should be understood, however, that any number of pieces or levels of information may be downloaded at times of low network usage. For instance, initial, second, third and fourth information may be downloaded at a time of low network usage, and fifth (and optionally sixth or further) information may then be downloaded or accessed over the internet, if desired by the user.

It is envisaged that such an information provision system 1 could be used to provide targeted advertisements in a cellular environment, to provide effective delivery of targeted advertisements to subscribers 40 who opt in to such a service. The data received by the action log 4 and analytics engine 5 could be used to recompense or provide rewards to subscribers 40 who view advertisements provided by the system.

Additionally, it is proposed that such an information provision system 1 could be used to provide important information 41, 42 to employees of a company. Such information 41, 42 may be provided as part of a ‘closed loop’ corporate communication system.

It is envisaged that handsets or devices provisioned or provided by the company may have the application installed, with the system 1 configured to provide daily information 41, 42 updates to employees of the company, who are effectively subscribers 40. The information provided to employees of the company may include daily announcements, sales opportunities, cross-selling opportunities, HR announcements, general updates or any other useful information 41, 42.

Additionally, suppliers, vendors and customers may be included as subscribers 40 of the system 1, with the information provided thereto tailored to their particular role or position.

As detailed above, the information 41, 42 may be shown immediately after the handset or device is unlocked. In this way, as discussed above, the information 41, 42 may immediately be displayed on the screen of the handset or device, prior to normal operation of the device, such that the employee must view the information 41, 42 before being able to access the unlocked device to continue normal operation. This, as discussed above, alters the normal user operation of the handset or device. Alternatively, the information 41, 42 may be shown in accordance with the methods detailed above.

Such methods of information 41, 42 display ensure that employees see and acknowledge the information 41, 42, as it is shown on their device without the employee seeking to view the information 41, 42 or having to actively launch an application on their handset or device to view the information 41, 42.

It is envisaged that the ‘share’ and ‘like’ features outlined above would not be included for information 41, 42 provided to company employees, suppliers, vendors and/or customers as part of a closed-loop information provision system 1.

The information 41, 42 provided to one group of subscribers 40, for instance vendors, may be confidential or commercially sensitive.

In general, the system 1 may be used to deliver updates during the course of a day, with the information 41, 42 being delivered at times of low network usage as detailed above, to ensure that the information 41, 42 is available to employees at the start of a day.

However, in addition to this, the system 1 may be used to provide information 41, 42 to company employees in real-time, with information 41, 42 being delivered to employees' handsets or devices in the event of system or server failure, or if an urgent alert or update must be provided.

The implementation of the system 1 for providing information 41, 42 to employees may not require use of the targeting engine 2, as all employees may be required to receive and read the same information 41, 42. However, a targeting engine 2 may be used to ensure that the correct employees receive the correct information 41, 42.

Use of the system in general will now be described.

In use, the system 1 would be configured to connect with a telecoms operator or operators 20 and an information provider 30. The telecoms operator or operators 20 may provide information regarding subscribers 40 to the system, and the information would be stored in the subscriber database 10. An information provider 30 would also provide information to be sent to subscribers 40, which would be stored in the information inventory 11.

Dependent upon the content of the information inventory 11 and the subscriber details in the subscriber database 10, the subscriber-information matching engine 12 would match information to subscribers 40, and would pass the information 41, 42 to the information serving engine 3. The information 41, 42 may then be transmitted to a subscriber or subscribers' handset(s) or device(s), at a period of low cellular data usage. The information 41, 42 would then be delivered to the subscriber or subscribers 40 and would be displayed, via a post-lock screen, at times or at a schedule or in a sequence determined by the scheduling engine 50.

Each handset or device would then provide information to the action log 4 and analytics engine 5, so that data regarding the information 41, 42 could be tracked.

Reports, as discussed above, could be run, to provide information regarding the usage of the system 1 and the behaviour of subscribers as a result of the information provided.

When the term ‘idle screen’ is used in this specification, it may include ‘post-lock’ screen, screen saver or background.

In the discussion above, reference is made to various software modules, or other aspects of software, which operate in the course of the invention. It should be understood that the software disclosed above is implemented with one or more processors, and the invention is therefore put into effect through a combination of software/computer programme and hardware.

This hardware includes, but is not limited to, one or more servers operated by the provider of the service, or by third parties, one or more processors which form part of a user's handheld device, display components of the handheld device, and hardware involved in the transmission of data between the server(s) and the handheld device(s).

In the discussion above, the initial and/or second (or subsequent) information may comprise a video sequence. A video sequence will generally have a predefined length. If, for example, the initial information is a video sequence, the first length of time may be equal or substantially equal to the length of the video sequence. However, in other embodiments the first length of time may be different from the length of the video sequence. For example, the first length of time may be longer than the video sequence. After the video sequence has finished, the user may be presented with a looped sequence of all or part of the video sequence, or with a still image of part of the video sequence. In this way the first length of time is not constrained to be the same as the length of the video sequence. This may be of particular usefulness if the first length of time is to include an element of randomisation.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A system for delivering information to a handheld device, the system comprising:
an information inventory containing information to be delivered, an information serving engine, a targeting engine, a subscriber database and a subscriber-information matching arrangement, wherein:
the subscriber database contains information about subscribers to which information is to be provided, and the targeting engine is configured to determine which information is to be provided to which subscribers and at what time and/or date, based on information regarding the subscribers stored in the subscriber database;
the subscriber-information matching arrangement takes the information to be delivered during a predetermined period and the selected subscribers and matches them together; and
the information to be delivered during the predetermined period is delivered to the selected subscribers by transmitting the information to the handheld device at a time of low network usage, and the information includes display schedule data, instructing that the information is displayed to the subscriber on the handheld device at the set times and/or dates, to be viewed by the subscriber, and the information to be delivered takes the form of a combination of initial information and second information, and first time data representing a first length of time associated with the initial information, where the second information is related to the initial information, and the initial and second information are stored as separate data files, wherein:
the initial information is displayed to user for a first length of time;
the first information is replaced by the second information after a first length of time without any action being required on the user's part.

2. The system of claim 1, wherein the initial information and second information are stored in different file formats.

3. The system of claim 2, wherein the initial information is stored as one of: a still image file, a video file, and a web page file; and optionally wherein the second information is stored as one of: a single image file, a video file, and a web page file, and is not stored as the same one of these as which the initial information is stored.

4. (canceled)

5. The system of claim 1, wherein the first length of time is fixed in length.

6. The system of claim 1, wherein the first length of time has at least an element of randomization.

7. (canceled)

8. The system of claim 1, wherein the first length of time is not connected with any loading time for the second information.

9. The system of claim 1, wherein the information to be delivered further comprises second time data, wherein the second information is displayed for a second length of time which is dictated by the second time data; and optionally wherein following the second length of time, the handheld device is returned to normal operation.

10. (canceled)

11. The system of claim 1, wherein during the display of either the initial information or the second information on the handheld device, the user may dismiss the initial or second information and return to the normal operation of the handheld device.

12. The system of claim 1, wherein during the display of the initial information and/or the second information, the user may interact with the initial and/or second information to establish a connection over the internet with a third party.

13. (canceled)

14. The system of claim 12, wherein if the user interacts with the initial and/or second information to establish a connection over the internet with a third party, further information is downloaded to the handheld device from the third party for display or presentation on the device.

15. The system of claim 1, wherein the initial and second information and the first time data are transmitted to the handheld device together as a package of data.

16. (canceled)

17. (canceled)

18. (canceled)

19. (canceled)

20. The system of claim 1, wherein the set time is not the same as the predetermined delivery period.

21. The system of claim 1, wherein the information further includes a data flag which causes the information to be displayed when the handheld device is unlocked, altering the normal user navigation of the handheld device; and optionally wherein the data flag causes the information to be displayed on the screen of the handheld device immediately after the lock screen is dismissed, altering the normal user navigation of the handheld device.

22. (canceled)

23. (canceled)

24. (canceled)

25. The system of claim 1, wherein the initial information to be delivered includes a network service message, and the second information preferably allows the user to acknowledge that the network service message has been read.

26. The system of claim 1, wherein the initial information to be delivered includes a software update alert, and the second information preferably allows the user to acknowledge that the software update alert has been read.

27. (canceled)

28. (canceled)

29. The system of claim 9, wherein the second information is replaced by third information after the second length of time, without any action being required on the user's part, wherein the third information is related to the second information.

30. The system of claim 1, further comprising a handheld device, wherein the handheld device includes an application configured to receive and display the information delivered by the system, and wherein the application is configured to display the information according to the display schedule data.

31. The system of claim 30, wherein the application determines when the information is to be displayed on the device.

32. The system of claim 30, wherein the application is configured to display the information on a post-lock screen.

33. (canceled)

34. A method for delivering information, the method comprising:
providing information to be delivered, stored in an information inventory, to be delivered by an information serving engine;
analyzing information stored in a subscriber database about subscribers to which information is to be provided;
determining which information is to be provided to which subscribers and at what time and/or date by way of a targeting engine, the determination based on information regarding the subscribers stored in the subscriber database and the information stored in the information inventory;
providing a subscriber-information matching arrangement which determines which information is to be delivered during a predetermined period;
taking the information to be delivered during the predetermined period and the selected subscribers and matching them together;
determining when network usage is low;
delivering the information to be displayed during the predetermined period to the selected subscribers by transmitting the information to a handheld device at the determined time of low network usage;
including, in the information, display schedule data which instructs a handheld device to display the information and
displaying the information to a subscriber on a handheld device at the set times and/or dates, to be viewed by the subscriber, wherein the information to be delivered takes the form of a combination of initial information and second information, and first time data representing a first length of time associated with the initial information, where the second information is related to the initial information, and the initial and second information are stored as separate data files, wherein:
the initial information is displayed to the user for a first length of time;
the first information is replaced by the second information after a first length of time without any action being required on the user's part.
